(19) United States
(12) Patent Application Publication
(10) Pub. No.: US 2025/0093162 A1
(43) Pub. Date: Mar. 20, 2025

(54) INFORMATION PROVISION APPARATUS, TERMINAL APPARATUS, INFORMATION PROVISION METHOD, AND NON-TRANSITORY COMPUTER-READABLE STORAGE MEDIUM

(71) Applicant: NEC Corporation, Minato-ku, Tokyo (JP)

(72) Inventors: Takatoshi KINO, Tokyo (JP); Masahiro SEKIGUCHI, Tokyo (JP)

(73) Assignee: NEC Corporation, Minato-ku, Tokyo (JP)

(21) Appl. No.: 18/726,853

(22) PCT Filed: Jan. 14, 2022
(86) PCT No.: PCT/JP2022/001041

§ 371 Date: Jul. 5, 2024

(51) Int. Cl. G01C 21/20

(52) U.S. Cl. CPC G01C 21/206

(57) ABSTRACT

An information provision apparatus (10) includes an acquisition unit (110), a position determination unit (120), a route generation unit (130), an advertisement selection unit (140), and a transmission unit (150). The acquisition unit (110) acquires an image from a terminal apparatus 20 held by a user located in a facility. The position determination unit (120) generates, by processing the image, first position information indicating a position of the user. The route generation unit (130) generates, by using the first position information, route information indicating a route that the user is to move. The advertisement selection unit (140) selects, by using the first position information, advertisement information to be provided to the user. The transmission unit (150) transmits, to the terminal, the route information and the advertisement information being selected.

### TECHNICAL FIELD

The present invention relates to an information provision apparatus, a terminal apparatus, an information provision method, and a program.

### BACKGROUND ART

One piece of information to be provided to a user is route guidance. For example, Patent Document 1 discloses the following system. First, an image capturing unit acquires, as a captured image, scenery at a current location where a user is present. A recognition unit decides a current location by recognizing a predetermined image capturing target from the captured image. A search unit searches for a route from the current location to a destination. A provision unit provides information to a user. A control unit controls in such a way as to provide the provision unit with provision information for route guidance, the provision information including a scenery image on the route.

Note that, Patent Document 2 describes that, when a camera unit captures an image at a certain floor, a guidance route is displayed on the captured image in a superposing manner, the guidance route including information relating to shops present on the certain floor and other floors above and below the certain floor, a congestion state of each shop, and a shop planned to visit.

### RELATED DOCUMENTS

### Patent Documents

Patent Document 1: Japanese Patent Application Publication No. 2015-129696

Patent Document 2: Japanese Patent Application Publication No. 2012-108053

### SUMMARY OF INVENTION

### Technical Problem

The present inventor has considered enhancing value of information to be provided to a user when route guidance information is provided to the user. One example of the objects of the present invention is to enhance value of information to be provided to a user when route guidance information is provided to the user.

### Solution to Problem

According to one aspect of the present invention, there is provided an information provision apparatus including:
an acquisition unit that acquires an image from a terminal held by a user located in a facility;
a position determination unit that generates, by processing the image, first position information indicating a position of the user;
a route generation unit that generates, by using the first position information, route information indicating a route that the user is to move;
an advertisement selection unit that selects, by using the first position information, advertisement information to be provided to the user; and
a transmission unit that transmits, to the terminal, the route information and the advertisement information being selected.

According to one aspect of the present invention, there is provided a terminal apparatus including:
a communication unit that acquires the advertisement information and the route information from the information provision apparatus described above; and
a display control unit that displays the advertisement information on a screen, and also displays a mark on the screen by using a current position of a user and the route information, the mark indicating a direction in which the user is to move.

According to one aspect of the present invention, there is provided an information provision method including,
by a computer executing:
   acquisition processing of acquiring an image from a terminal held by a user located in a facility;
   position determination processing of generating, by processing the image, first position information indicating a position of the user;
   route generation processing of generating, by using the first position information, route information indicating a route that the user is to move;
   advertisement selection processing of selecting, by using the first position information, advertisement information to be provided to the user; and
   transmission processing of transmitting, to the terminal, the route information and the advertisement information being selected.

According to one aspect of the present invention, there is provided an advertisement display method including,
by a computer executing:
   communication processing of acquiring the advertisement information and the route information from the information provision apparatus described above; and
   display control processing of displaying the advertisement information on a screen, and also displaying a mark on the screen by using a current position of a user and the route information, the mark indicating a direction in which the user is to move.

According to one aspect of the present invention, there is provided a program causing a computer to include:
an acquisition function of acquiring an image from a terminal held by a user located in a facility;
a position determination function of generating, by processing the image, first position information indicating a position of the user;
a route generation function of generating, by using the first position information, route information indicating a route that the user is to move;
an advertisement selection function of selecting, by using the first position information, advertisement information to be provided to the user; and
a transmission function of transmitting, to the terminal, the route information and the advertisement information being selected.

According to one aspect of the present invention, there is provided a program causing a computer to include:
a communication function of acquiring the advertisement information and the route information from the information provision apparatus described above; and
a display control function of displaying the advertisement information on a screen, and also displaying a mark on the screen by using a current position of a user and the route information, the mark indicating a direction in which the user is to move.

### Advantageous Effects of Invention

According to one aspect of the present invention, value of information to be provided to a user is enhanced when route guidance information is provided to the user.

### BRIEF DESCRIPTION OF THE DRAWINGS

The above-mentioned object, other objects, features, and advantages are further clarified with reference to the suitable example embodiments describe below and the following drawings accompanying therewith.

FIG. 1 It is a diagram for describing a usage environment of an information provision apparatus according to an example embodiment.

FIG. 2 It is a diagram illustrating one example of a functional configuration of the information provision apparatus.

FIG. 3 It is a diagram illustrating one example of information stored in a route-related storage unit.

FIG. 4 It is a diagram illustrating one example of information stored in an advertisement storage unit.

FIG. 5 It is a diagram illustrating one example of information stored in a user storage unit.

FIG. 6 It is a diagram illustrating one example of a functional configuration of a terminal apparatus.

FIG. 7 It is a diagram illustrating a hardware configuration example of the information provision apparatus.

FIG. 8 It is a flowchart illustrating one example of processing executed by the information provision apparatus.

FIG. 9 It is a diagram illustrating one example of processing of the information provision apparatus when advertisement information displayed by the terminal apparatus is selected by a user.

### EXAMPLE EMBODIMENT

An example embodiment of the present invention is described below with reference to the drawings. Note that, in all the drawings, a similar constituent element is denoted with a similar reference sign, and description therefor is not included as appropriate.

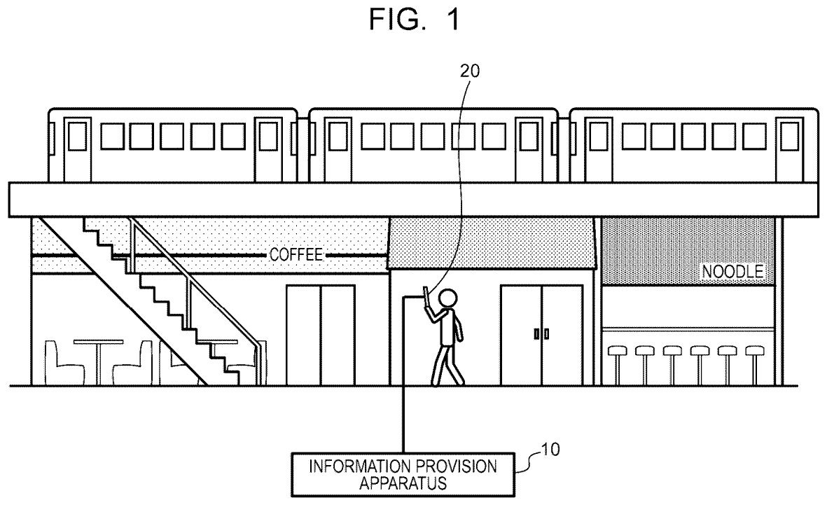

FIG. 1 is a diagram for describing a usage environment of an information provision apparatus 10 according to the example embodiment. The information provision apparatus 10 is used together with a terminal apparatus 20. The terminal apparatus 20 is held by a user walking within a facility. Further, the information provision apparatus 10 provides the terminal apparatus 20 with route information and advertisement information. One example of the facility includes a facility for boarding and alighting public transportation, such as a station, an airport, and a bus terminal, and may include other facilities such as a shopping mall and an amusement park.

For example, the terminal apparatus 20 includes a position detection function such as a GPS function. The terminal apparatus 20 is capable of detecting entry of a user in a facility by using the position detection function. Further, when the user requires route guidance to a destination in the facility, the terminal apparatus 20 is used to capture an image of a peripheral area at a current position. The terminal apparatus 20 transmits the image being generated to the information provision apparatus 10. In this state, the terminal apparatus 20 preferably transmits the image to the information provision apparatus 10 in real time. For example, the terminal apparatus 20 transmits the image to the information provision apparatus 10 at a predetermined frame rate (for example, 0.2 fps or more and 1 fps or less). Note that, destination information indicating the destination is transmitted from the terminal apparatus 20 to the information provision apparatus 10 at least one of before and after transmission of the image or at the same time as transmission of the image.

The information provision apparatus 10 determines a current position of a user in a facility by processing an image being received from the terminal apparatus 20. Hereinafter, information indicating the current position is referred to as first position information. Further, the information provision apparatus 10 generates first route information by using the first position information and the destination information, and transmits the first route information to the terminal apparatus 20, the first route information indicating a route that the user is to move in the facility. In this state, the information provision apparatus 10 also transmits, to the terminal apparatus 20, advertisement information to be provided to the user. For example, the advertisement information relates to the facility where the user is currently located, or may relate to a shop positioned outside of the facility.

One example of the destination being set by a user is a specific location in the facility. When the facility is a station, an airport, a bus terminal, or the like, one example of the destination is a platform, a boarding gate, or a bus stop.

However, there may be a case in which a real destination of a user is outside of a facility, and the facility is merely a transit point. In this case, the terminal apparatus 20 may display the first route information described above as part of second route information indicating a route to the real destination. In this case, the second route information includes a moving route outside a facility, for example, a moving route using public transportation, in addition to the first route information. Note that, the second route information may be generated by the information provision apparatus 10, or may be generated by a route guidance apparatus other than the information provision apparatus 10.

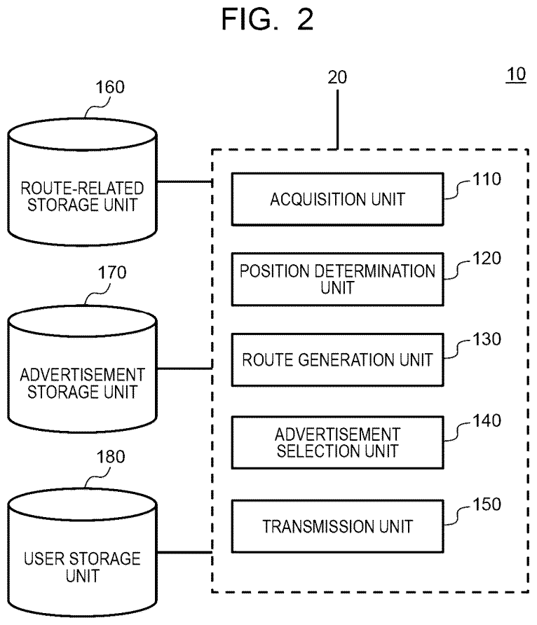

FIG. 2 is a diagram illustrating one example of a functional configuration of the information provision apparatus 10. The information provision apparatus 10 includes an acquisition unit 110, a position determination unit 120, a route generation unit 130, an advertisement selection unit 140, and a transmission unit 150, and can use a route-related storage unit 160, an advertisement storage unit 170, and a user storage unit 180. In the example illustrated in the present drawing, the route-related storage unit 160, the advertisement storage unit 170, and the user storage unit 180 are parts of the information provision apparatus 10. However, those units may be positioned outside of the information provision apparatus 10.

The route-related storage unit 160 stores information required for generating the first route information and information required for generating the first position information. Further, when the route-related storage unit 160 generates the second route information, the route-related storage unit 160 also stores information required for generating the second route information. One example of information stored in the route-related storage unit 160 is described later with reference to another drawing.

The advertisement storage unit 170 stores the advertisement information to be provided to a user. One example of information stored in the advertisement storage unit 170 is described later with reference to another drawing.

The user storage unit 180 stores user identification information and information relating to a user in association with each other for each user. One example of information stored in the user storage unit 180 is described later with reference to another drawing.

The acquisition unit 110 acquires the user identification information relating to a user of the terminal apparatus 20. Further, the terminal apparatus 20 acquires, from the terminal apparatus 20, information indicating a position detected by the position detection function at timing when a user enters a facility. Hereinafter, the position information is referred to as second position information. Further, the acquisition unit 110 acquires the destination information from the terminal apparatus 20. A position indicated in the destination information may be inside a facility, or may be outside the facility. Further, the acquisition unit 110 acquires, from the terminal apparatus 20, an image being generated in the facility by the terminal apparatus 20. The image indicates a current position of a user of the terminal apparatus 20.

The position determination unit 120 generates the information indicating the current position of a user in a facility, in other words, the first position information described above, by processing an image being acquired by the acquisition unit 110. In this state, the position determination unit 120 uses the information stored in the route-related storage unit 160.

The route generation unit 130 generates the first route information by using the destination information being acquired by the acquisition unit 110 and the first position information being generated by the position determination unit 120. Herein, when the destination information indicates a position outside a facility, the route generation unit 130 first generates or acquires the second route information. Further, when a user moves according to the second route information, the route generation unit 130 determines a place to which the user is to head in the facility, for example, a platform, a boarding gate, or a bus stop. Further, the route generation unit 130 regards information indicating the place as the destination information for generating the first route information.

As described above, the second route information may be generated by a route guidance apparatus other than the information provision apparatus 10. In this case, the route generation unit 130 transmits, to the route guidance apparatus, the second position information and the destination information being acquired from the terminal apparatus 20. Further, the route generation unit 130 acquires the second route information from the route guidance apparatus.

The advertisement selection unit 140 selects, by using the first position information, the advertisement information to be provided to a user from the advertisement information stored in the advertisement storage unit 170. A selection criterion for an advertisement, which is used herein, is described later with reference to another drawing.

The transmission unit 150 transmits, to the terminal apparatus 20, the first route information being generated by the route generation unit 130 together with the advertisement information being selected by the advertisement selection unit 140. The terminal apparatus 20 displays the first route information and the advertisement information. The terminal apparatus 20 may display those pieces of information at the same time. Further, when the route generation unit 130 generates or acquires the second route information, the transmission unit 150 also transmits the second route information to the terminal apparatus 20.

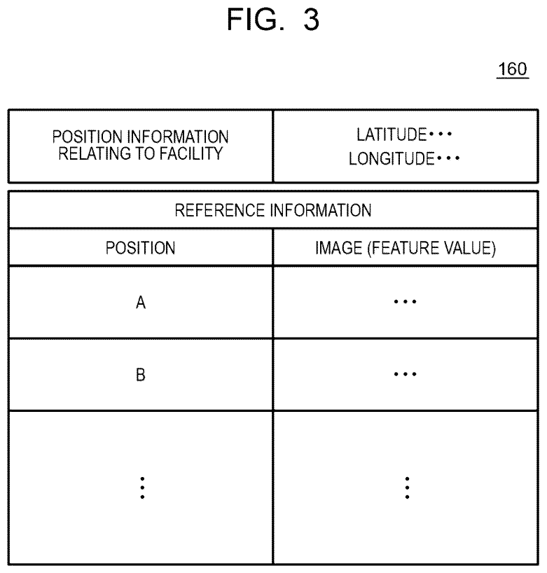

FIG. 3 is a diagram illustrating one example of the information stored in the route-related storage unit 160. The present drawing illustrates information required for generating the first position information from an image being generated by the terminal apparatus 20. Hereinafter, the information is referred to as reference information.

The reference information includes information indicating a position in a facility, and an image at the position or information associated with feature data relating to the image. Further, reference information that relates to a plurality of positions is set in one facility. The route-related storage unit 160 stores those plurality of pieces of reference information. Further, the position determination unit 120 of the information provision apparatus 10 generates the first position information by executing matching processing for the feature data with respect to an image being acquired from the terminal apparatus 20.

Note that, for each of a plurality of facilities, the route-related storage unit 160 store position information (for example, latitude/longitude information) relating to the facility and a plurality of pieces of reference information. When the second position information is acquired, the position determination unit 120 determines a facility corresponding to the second position information and the reference information associated with the facility. Further, the position determination unit 120 generates the first position information by using the reference information being determined.

Note that, in FIG. 3, the route-related storage unit 160 may store identification information relating to the facility, for example, a facility ID, in addition to the position information relating to the facility.

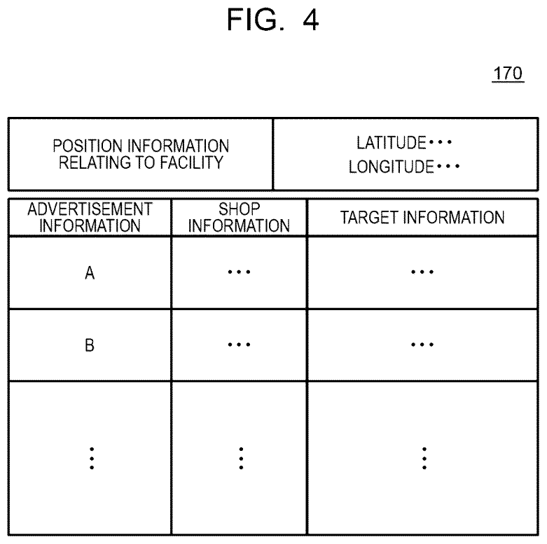

FIG. 4 is a diagram illustrating one example of the information stored in the advertisement storage unit 170. In the example illustrated in the present drawing, the advertisement storage unit 170 stores a plurality of pieces of advertisement information for each piece of facility position information. Further, for each of the plurality of pieces of advertisement information, the advertisement storage unit 170 stores information relating to a business being an advertiser, and information relating to a person being an advertisement target, in other words, target information. Those pieces of information are used when the advertisement selection unit 140 selects the advertisement information. Examples of the business being an advertiser include a shop that sells a product or provides service, public transportation such as a railroad, a bus, and a taxi, an information center installed in a facility such as a station, a bus terminal, and a shopping mall, and the like.

Shop information includes at least one of the following items, for example.
A shop name
A position of the shop in a facility
A business type
Business hours.
An image associated with the shop or feature data relating to the image
Availability of a limited-time product and description for the product

Herein, for example, the business type indicates a product type on sale or a service type being provided. The product type may include information indicating whether the product type represents a characteristic of a local area, for example, information indicating whether the product type is a typical souvenir.

The feature data relating to an image include, but not limited to, at least one of the following items, for example.
Feature data relating to an external appearance of the shop
Feature data relating to a signboard of the shop
Feature data relating to an advertisement of the shop
Feature data relating to an external appearance of a product being sold at the shop
Feature data relating to an external appearance of a wrapper or a bag provided by the shop

The target information stores attribution information relating to a user to be provided with the advertisement information. The attribution information includes at least one of the following items, for example.
Age and gender
Interests
A browsing tendency of Web sites
Shopping and food preference
Health information (for example, a medical history and whether to be on a diet)
A special occasion (for example, a birthday and a wedding anniversary)
A schedule

Note that, the advertisement storage unit 170 may further store information indicating a priority degree of the advertisement information. For example, the priority degree is set by using an advertising fee paid by an advertiser, presence or absence of a time sale, availability of a new product, time since opening of a shop (for example, a priority degree of advertisement information relating to a new shop is set higher), a congestion state of the shop (for example, a priority degree of advertisement information relating to a less congested shop is set higher), and the like. The advertisement selection unit 140 preferentially selects a piece of the advertisement information with a higher priority degree as compared to other pieces of the advertisement information.

Further, when the identification information relating to a facility is stored in FIG. 3, the advertisement storage unit 170 may store the identification information relating to the facility in place of the position information relating to the facility.

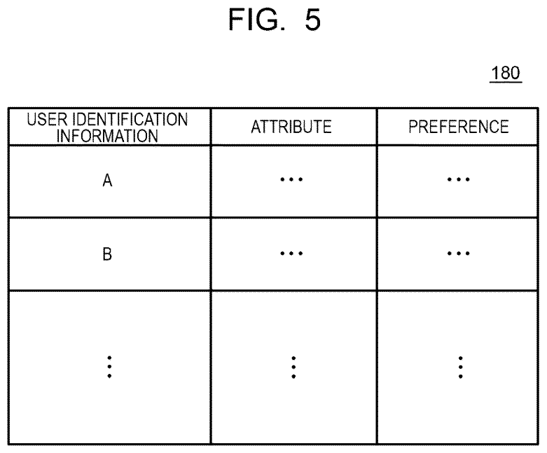

FIG. 5 is one example of the information stored in the user storage unit 180. The user storage unit 180 stores user identification information, an attribute, and preference for each user.

The user attribute includes at least one of the following items, for example.
Age and gender
A frequently used commuting route of public transportation, such as a section covered by a commuter pass
Health information (for example, a medical history and whether to be on a diet)
A special occasion (for example, a birthday and a wedding anniversary)
A schedule
A purpose of a current movement
The number of visits for each facility

The user preference includes at least one of the following items, for example.
Interests
A browsing tendency of Web sites
Shopping and food preference

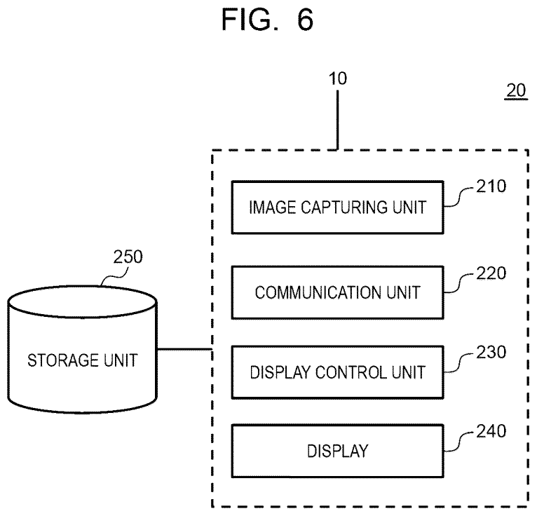

FIG. 6 is a diagram illustrating one example of a functional configuration of the terminal apparatus 20. In the example illustrated in the present drawing, the terminal apparatus 20 includes an image capturing unit 210, a communication unit 220, a display control unit 230, and a display 240, and can use information stored in a storage unit 250. For example, the storage unit 250 is a part of the terminal apparatus 20, and may be positioned outside of the terminal apparatus 20.

The image capturing unit 210 generates an image of a peripheral area of a user of the terminal apparatus 20.

The communication unit 220 transmits an image being generated by the image capturing unit 210 to the information provision apparatus 10. Further, the communication unit 220 acquires first route information, advertisement information, and first position information from the information provision apparatus 10. Note that, the first position information may be indicated as a starting point in the first route information. Further, the communication unit 220 causes the storage unit 250 to store the first route information and the advertisement information.

The display control unit 230 displays the first route information and the advertisement information that are stored in the storage unit 250, on the display 240. In this state, the display control unit 230 preferably displays the first route information and the advertisement information at the same time, on the display 240.

Further, the display control unit 230 displays a mark on the display 240 by using the first position information and the first route information, the mark indicating a direction in which a user is to move. When the display is performed, the display control unit 230 may display a map within a facility on the display 240, and display a route indicated in the first route information and the mark indicating the direction in which the user is to move, on the map. Further, the display control unit 230 may display, on the display 240 in real time, an image being generated by the image capturing unit 210, and display the mark indicating the direction in which the user is to move, on the image in an overlapping manner. In this case, the terminal apparatus 20 includes a sensor that detects an orientation of the terminal apparatus 20, and determines an orientation of the mark described above, by using a detection result of the sensor, the first position information, and the first route information.

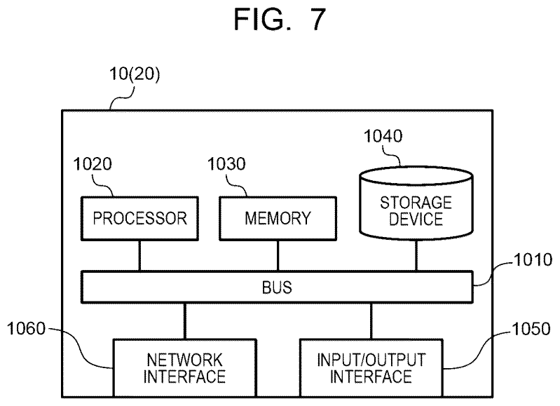

FIG. 7 is a block diagram illustrating a hardware configuration example of the information provision apparatus 10. The information provision apparatus 10 includes a bus 1010, a processor 1020, a memory 1030, a storage device 1040, an input/output interface 1050, and a network interface 1060.

The bus 1010 is a data transmission path in which the processor 1020, the memory 1030, the storage device 1040, the input/output interface 1050, and the network interface 1060 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a removable media such as a memory card, a read only memory (ROM), or the like. The storage device 1040 stores a program module for achieving each of the functions (for example, the acquisition unit 110, the position determination unit 120, the route generation unit 130, the advertisement selection unit 140, and the transmission unit 150) of the information provision apparatus 10. The processor 1020 reads each of the program modules on the memory 1030 and executes the program module, and thereby each of the functions associated with each of the program modules is achieved. Further, the storage device 1040 also functions as the route-related storage unit 160, the advertisement storage unit 170, and the user storage unit 180.

The input/output interface 1050 is an interface for connecting the information provision apparatus 10 and various input/output devices to each other.

The network interface 1060 is an interface for connecting the information provision apparatus 10 to a network. For example, the network is a local area network (LAN) or a wide area network (WAN). A method of connecting the network interface 1060 to the network may be wireless connection, or may be wired connection. The information provision apparatus 10 communicates with the terminal apparatus 20 via the network interface 1060.

Note that, a hardware configuration of the terminal apparatus 20 is similar to the hardware configuration of the information provision apparatus 10 illustrated in FIG. 7.

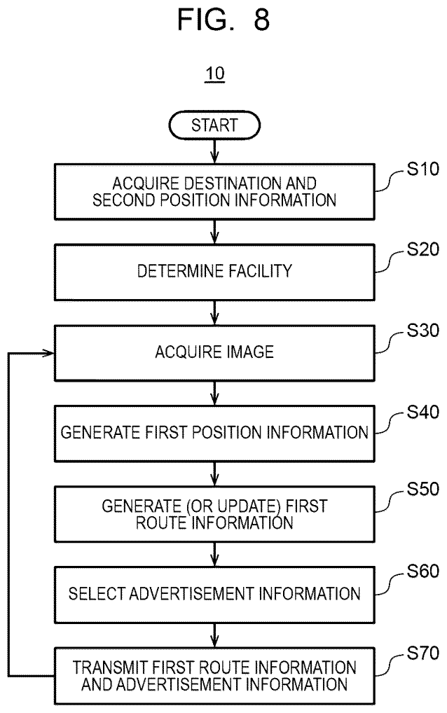

FIG. 8 is a flowchart illustrating one example of processing executed by the information provision apparatus 10. In this example, the terminal apparatus 20 acquires second route information before entry in a facility. Further, the terminal apparatus 20 transmits user identification information in advance to the information provision apparatus 10. Further, a user of the terminal apparatus 20 moves according to the second route information, and enters a facility being a target for which first route guidance is generated. When it is detected that the terminal apparatus 20 enters the facility by using a detection result of a position detection function included in the terminal apparatus 20, the terminal apparatus 20 transmits a current position of the terminal apparatus 20, in other words, the second position information to the information provision apparatus 10.

In this state, the terminal apparatus 20 determines a destination to which the user is to move in the facility, by using the second route information, and also transmits information indicating the destination, in other words, destination information to the information provision apparatus 10. Note that, the processing may be executed by the information provision apparatus 10. In this case, the information provision apparatus 10 stores the second route information in advance in association with the user identification information.

Further, when entering the facility, the user causes the terminal apparatus 20 to capture an image of a peripheral area thereof, and to transmit an image being generated to the information provision apparatus 10. The terminal apparatus 20 repeats image capturing and transmission until the user arrives at the destination.

The specific examples of image capturing and transmission described above are, but not limited to, the following cases, for example.
The terminal apparatus 20 captures a video, and transmits frames of the video at all times. In this state, the advertisement selection apparatus 20 may selectively skip frames.
The terminal apparatus 20 may repeatedly capture a still image, and transmit the still image. Timing of capturing a still image may be automatically performed by the terminal apparatus 20 according to a setting, for example, at a predetermined interval, or may be timing when the user operates, in other words, timing when an instruction is input.

The acquisition unit 110 of the information provision apparatus 10 acquires the destination information and the second position information from the terminal apparatus 20 (step S10), and then determines the facility that the user enters, by using the second position information (step S20).

Further, the information provision apparatus 10 repeats processing in step S30 to step S70 until the user arrives at the destination.

First, the acquisition unit 110 acquires an image from the terminal apparatus 20 (step S30). Then, the position determination unit 120 determines reference information corresponding to the facility being determined in step S20, among the reference information stored in the route-related storage unit 160. Further, the position determination unit 120 determines the reference information whose feature data matches with the image being acquired in step S30, among the reference information being determined, and reads a position associated with the reference information from the route-related storage unit 160. In this manner, first position information, in other words, information indicating a current position of the user is generated (step S40).

Further, by using the destination information, the first position information, and the information stored in the route-related storage unit 160, the route generation unit 130 generates first route information, in other words, information indicating a route from the current position being generated in step S40 to the destination being acquired in step S10 (step S50).

Further, the advertisement selection unit 140 determines a plurality of pieces of advertisement information corresponding to the facility being determined in step S20, among the advertisement information stored in the advertisement storage unit 170. Further, the advertisement selection unit 140 selects the advertisement information to be provided to the terminal apparatus 20, from the plurality of pieces of advertisement information (step S60). For example, a criterion of the selection is as described in (Example 1) to (Example 7) given below.

### Example 1

The advertisement selection unit 140 reads at least one of attribution information and preference information that relate to the user from the user storage unit 180 by using the user identification information being acquired from the terminal apparatus 20, and selects the advertisement information by using the information being read. Examples of the attribution information and processing are, for example, (Example 1-1) to (Example 1-7) given below. Further, the example of the attribution information and the processing may be a combination of at least two or more of the examples.

### Example 1-1

The advertisement selection unit 140 reads at least one of age and gender of a user. Further, the advertisement selection unit 140 selects advertisement information in which target information includes the information being read, from the advertisement storage unit 170. For example, the advertisement selection unit 140 selects advertisement information relating to a shop (for example, a clothing shop) whose target information includes the gender of the user. Further, the advertisement selection unit 140 selects advertisement information relating to a shop whose target information includes the age of the user.

### Example 1-2

The advertisement selection unit 140 reads preference of a user. Further, the advertisement selection unit 140 selects advertisement information in which target information includes the information being read, from the advertisement storage unit 170. For example, when the preference information includes a favorite item of the user, the advertisement selection unit 140 selects advertisement information relating to a shop that provides the favorite item, from the advertisement storage unit 170.

### Example 1-3

The advertisement selection unit 140 reads a user's browsing tendency of Web sites. Further, the advertisement selection unit 140 estimates preference of the user, based on the browsing tendency being read, and selects advertisement information in which target information includes the preference being estimated, from the advertisement storage unit 170, similarly to (Example 1-2) described above.

### Example 1-4

The advertisement selection unit 140 reads a special occasion of a user. Further, when the special occasion is within predetermined days from a current day (including the same day), the advertisement selection unit 140 determines a business type associated with a type of the special occasion (for example, a type of a product being sold), and selects advertisement information relating to the business type from the advertisement storage unit 170. In this case, the advertisement selection unit 140 stores a type of a special occasion and a type of a product in advance in association with each other.

### Example 1-5

The advertisement selection unit 140 reads a schedule of a user within predetermined days from a current day. Further, the advertisement selection unit 140 determines a business type associated with a type of a plan included in the schedule (for example, a type of a product being sold), and selects advertisement information relating to the business type from the advertisement storage unit 170. For example, the advertisement selection unit 140 selects advertisement information relating to a shop that sells a product that may be used for the plan. In this case, the advertisement selection unit 140 stores a type of a schedule and a type of a product in advance in association with each other.

### Example 1-6

The advertisement selection unit 140 reads health information relating to a user. Further, the advertisement selection unit 140 determines a business type associated with the health information (for example, a type of a product being sold), and selects advertisement information relating to the business type from the advertisement storage unit 170. In this case, the advertisement selection unit 140 stores a content of health information and a type of a product in advance in association with each other. For example, the health information includes information indicating “being on a diet”, the advertisement selection unit 140 selects advertisement information relating to a low-calorie food from the advertisement storage unit 170. Further, when the health information includes a medical history, the advertisement selection unit 140 selects advertisement information relating to a food corresponding to the medical history from the advertisement storage unit 170.

### Example 1-7

The advertisement selection unit 140 reads information indicating a purpose of current movement of a user from the user storage unit 180. Further, by using the information, the advertisement selection unit 140 selects advertisement information from the advertisement storage unit 170. In this case, the advertisement selection unit 140 stores a purpose of movement and a type of a product in advance in association with each other. For example, when the user is on a business trip, the advertisement selection unit 140 selects advertisement information relating to a shop that sells a business-related product or a product being a souvenir. Further, when the user moves for tourism, the advertisement selection unit 140 selects advertisement information relating to a shop that sells a product necessary for travel or a product being a souvenir. Note that, when information indicating a purpose of movement is not stored in the user storage unit 180, and the facility is a station or a stop outside of a section covered by a commuter pass, the advertisement selection unit 140 decides that the user moves for tourism.

Further, when the information indicating a purpose of move is not stored in the user storage unit 180, and the facility is a station or a stop within a section covered by a commuter pass, the advertisement selection unit 140 selects advertisement information relating to a shop that sells a business-related or academic product, or a daily dish.

### Example 2

The advertisement selection unit 140 determines a current date and time, and selects advertisement information by using the date and time. In this case, the advertisement selection unit 140 stores a dates and time, for example, a time period and a business type of a shop in advance in association with each other. For example, the advertisement selection unit 140 selects a business type of a shop by using a time, and selects advertisement information relating to the business type being selected. For example, the advertisement selection unit 140 selects advertisement information relating to a café in the morning (for example, before 10:00), selects advertisement information relating to a restaurant serving a lunch at noon (for example, after 11:00 and before 14:00), and selects advertisement information relating to a shop that sells a daily dish or a souvenir around a homecoming time (for example, after 17:00). Further, the advertisement selection unit 140 may select advertisement information by using a current date. For example, the advertisement selection unit 140 may select advertisement information relating to a product used for cherry-blossom viewing during a cherry-blossom viewing season, and may select advertisement information relating to a product relating to a pumpkin or a costume during the Halloween season.

### Example 3

The advertisement selection unit 140 selects an advertisement by using an object captured in an image being acquired by the acquisition unit 110. Specifically, for example, the advertisement selection unit 140 decides whether any of the following objects is captured, by processing an image.
An external appearance of a shop
A signboard of a shop
An advertisement of a shop being held on a utility pole or the like
An external appearance of at least one of a bag, a wrapper, and a product held by another person
Clothing of a user or another person

Further, when at least one of an external appearance, a signboard, a product, a wrapper, a bag, and an advertisement of a shop is detected from an image, the advertisement selection unit 140 selects, from the advertisement storage unit 170, advertisement information in which shop information includes an object being detected.

Further, when clothing of a user or another person is detected from an image, the advertisement selection unit 140 selects advertisement information relating to a product according to the clothing. For example, the advertisement selection unit 140 selects advertisement information relating to a hot product (for example, a beverage or food) when the clothing being detected is thick clothing, and selects advertisement information relating to a cold product (for example, a beverage or food) when the clothing being detected is thin clothing.

Note that, an image being acquired in step S30 may include a plurality of frame images. In this case, a frame image suitable for generating the first position information and a frame image suitable for selecting the advertisement information may be different from each other. In this case, at least one of the frame images being used by the position determination unit 120 is not used by the advertisement selection unit 140. Alternatively, at least one of the frame images being used by the advertisement selection unit 140 is not used by the position determination unit 120.

### Example 4

For example, the advertisement selection unit 140 acquires current weather information around a facility from a server that stores weather information, and selects advertisement information by using the weather information. For example, the advertisement selection unit 140 selects advertisement information relating to a hot product (for example, a beverage or food) when air temperature is low, and selects advertisement information relating to a cold product (for example, a beverage or food) when air temperature is high. Further, the advertisement selection unit 140 selects advertisement information relating to a rain gear when it is rainy.

Further, the advertisement selection unit 140 may select advertisement information by using both the weather information and the route information. For example, when it is rainy, and a first route or a second route includes an outdoor space, the advertisement selection unit 140 may select advertisement information relating to a rain gear.

### Example 5

When the first route information and the first position information are used, a moving direction of a user can be estimated. The advertisement selection unit 140 may select advertisement information by using the traveling direction. For example, the advertisement selection unit 140 selects advertisement information relating to a shop present in the traveling direction. Note that, when the position determination unit 120 estimates a moving direction of the user by image processing, the advertisement selection unit 140 may use the information.

### Example 6

The advertisement selection unit 140 may select advertisement information by using a priority degree being set for the advertisement information. Further, the advertisement selection unit 140 preferentially selects a piece of the advertisement information with a higher priority degree.

### Example 7

the advertisement selection unit 140 may select advertisement information by using the number of visits to a facility by a user. For example, when the number of visits to the facility is small, the advertisement selection unit 140 selects advertisement information relating to a shop that sells a product representing a characteristic of the local area. On the other hand, when the number of visits to the facility is small, the advertisement selection unit 140 selects advertisement information relating to a shop that does not sell such a product.

After the advertisement selection unit 140 selects the advertisement information (step S60), the transmission unit 150 transmits, to the terminal apparatus 20, the first route information being generated in step S50 and the advertisement information being selected in step S60 (step S70).

After that, the display control unit 230 of the terminal apparatus 20 displays the first route information being transmitted from the information provision apparatus 10 on the display 240, and also displays the advertisement information being transmitted from the information provision apparatus 10. Herein, while the first route information is displayed, the display control unit 230 preferably displays the advertisement information at all times. However, when a predetermined time elapses after the advertisement information is displayed, the display control unit 230 may hide the advertisement information. Further, when the information provision apparatus 10 transmits a plurality of pieces of advertisement information, the display control unit 230 may display the plurality of pieces of advertisement information in a switching manner, or may display in a simultaneous manner. Further, when a user performs an input for updating the advertisement information, for example, selects an updating button, the display control unit 230 may change the advertisement information being displayed.

Further, the display control unit 230 may display a mark for displaying the advertisement information on the display 240 when the first route information is first displayed. In this case, when the mark is selected, the display control unit 230 displays the advertisement information on the display 240. Further, the display control unit 230 may first display an overview of the advertisement information on the display 240, and display details of the advertisement information on the display 240 when the overview is selected. In this case, the communication unit 220 of the terminal apparatus 20 may acquire the details of the advertisement information from the information provision apparatus 10 when the details are displayed.

As described above, the information provision apparatus 10 repeats the processing described in step S30 to step S70. With this, for example, while moving according to the first route information, a user of the terminal apparatus 20 may notice an interesting advertisement or belongings owned by another person (for example, a paper bag, a wrapper, or a product). In this case, the user uses the terminal apparatus 20 to capture an image of the belongings, and transmits it to the information provision apparatus 10. Then, through the processing in step S30 to step S70, the terminal apparatus 20 is capable of acquiring and displaying the advertisement information relating to the belongings on the display 240.

Note that, in a second or subsequent loop, step S50, in other words, processing of generating the first route information may be not included.

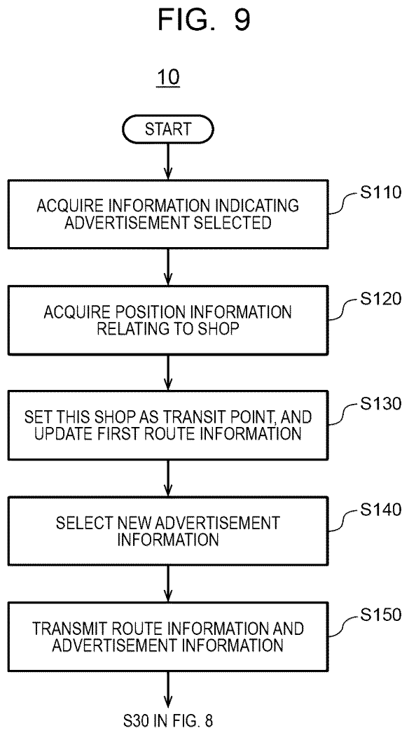

FIG. 9 is a diagram illustrating one example of processing of the information provision apparatus 10 when advertisement information displayed by the terminal apparatus 20 is selected by a user. When a user selects advertisement information, the terminal apparatus 20 transmits information indicating the advertisement information to the information provision apparatus 10.

The acquisition unit 110 of the information provision apparatus 10 acquires the information (step S110). Then, the position determination unit 120 acquires position information relating to a shop being an advertiser of the advertisement information being selected, by using the advertisement storage unit 170 (step S120), and updates the first route information in such a way that a position indicated in the position information becomes a transit point (step S130).

Further, the advertisement selection unit 140 selects new advertisement information (step S140). A selection criterion for the advertisement information in this state is similar to that described in step S80 in FIG. 8, except that the advertisement information being selected in step S60 in FIG. 8 is removed from a candidate. Further, the transmission unit 150 transmits, to the terminal apparatus 20, the first route information being updated in step S130 and the advertisement information being newly selected in step S140.

Further, the terminal apparatus 20 displays the first route information being newly received, and also displays the advertisement information being newly received. Those display modes are as described with reference to FIG. 8.

Note that, the information provision apparatus 10 may cause the user storage unit 180 to store information for determining a shop being an advertiser of the advertisement information being selected, in association with the user. In this case, in a case in which the same user visits the same facility again, when the first route information is generated, the route generation unit 130 of the information provision apparatus 10 may set a shop stored in the user storage unit 180 as a transit point.

As described above, when route guidance information is provided to a user, the information provision apparatus 10 provides advertisement information to the user. With this, value of information being provided to a user by the information provision apparatus 10 is enhanced.

While the example embodiments of the present invention are described above with reference to the drawings, those are merely examples of the present invention, and various configurations other than the above-mentioned configurations may be adopted.

Further, in a plurality of flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments described above may be combined with each other within a range where the contents do not conflict with each other.

The whole or a part of the example embodiments described above can be described as, but not limited to, the following supplementary notes.
1. An information provision apparatus including:
   an acquisition unit that acquires an image from a terminal held by a user located in a facility;
   a position determination unit that generates, by processing the image, first position information indicating a position of the user;
   a route generation unit that generates, by using the first position information, route information indicating a route that the user is to move;
   an advertisement selection unit that selects, by using the first position information, advertisement information to be provided to the user; and
   a transmission unit that transmits, to the terminal, the route information and the advertisement information being selected.
2. The information provision apparatus according to the above described 1, wherein
   the image is captured in a facility,
   the acquisition unit acquires, from the terminal, second position information indicating a position of the user at a time of entry in the facility, and
   the position determination unit determines the facility by using the second position information, and generates the first position information by using reference information being associated with the facility being determined.
3. The information provision apparatus according to the above described 1 or 2, wherein
   the advertisement selection unit further selects advertisement information by using a time or a date.
4. The information provision apparatus according to any one of the above described 1 to 3, wherein
   the advertisement selection unit further selects the advertisement information by using an object captured in the image.
5. The information provision apparatus according to the above described 4, wherein
   the image includes a plurality of frame images, and
   at least one of the frame images being used by the position determination unit is not used by the advertisement selection unit, or
   at least one of the frame images being used by the advertisement selection unit is not used by the position determination unit.
6. The information provision apparatus according to any one of the above described 1 to 5, wherein
   the advertisement selection unit further selects the advertisement information by using a moving direction of the user.
7. The information provision apparatus according to any one of the above described 1 to 6, wherein
   the advertisement selection unit selects the advertisement information by using at least one of clothing of a person captured in the image and air temperature.
8. The information provision apparatus according to any one of the above described 1 to 7, wherein
   the advertisement selection unit selects the advertisement information by using at least one of attribution information and preference information that relate to the user.
9. The information provision apparatus according to the above described 8, wherein
   the facility is a stop of public transportation, and
   the attribution information includes a purpose of movement using the public transportation by the user.
10. The information provision apparatus according to any one of the above described 1 to 9, wherein
   the advertisement selection unit selects the advertisement information by using a number of visits to the facility by the user.
11. The information provision apparatus according to any one of the above described 1 to 10, wherein
   the advertisement information relates to a shop in the facility,
   when information indicating that the advertisement information is selected is acquired from the terminal, the route generation unit adds a shop corresponding to the advertisement information as a transit point, and generates the route information being updated, and
   the transmission unit transmits the route information being updated to the terminal.
12. The information provision apparatus according to the above described 11, wherein,
   when the route information being updated is generated, the advertisement selection unit selects the advertisement information being new, and
   the transmission unit transmits the new advertisement information being selected to the terminal together with the route information being updated.
13. A terminal apparatus including:
   a communication unit that acquires the advertisement information and the route information from an information provision apparatus according to any one of the above described 1 to 12; and
   a display control unit that displays the advertisement information on a screen, and also displays a mark on the screen by using a current position of a user and the route information, the mark indicating a direction in which the user is to move.
14. An information provision method including,
   by a computer executing:
      acquisition processing of acquiring an image from a terminal held by a user located in a facility;
      generating, by processing the image, first position information indicating a position of the user;
      generating, by using the first position information, route information indicating a route that the user is to move;
      selecting, by using the first position information, advertisement information to be provided to the user; and
      transmitting, to the terminal, the route information and the advertisement information being selected.
15. The information provision method according to the above described 14, wherein
   the image is captured in a facility,
   the information provision method further including,
   by the computer:
      acquiring, from the terminal, second position information indicating a position of the user at a time of entry in the facility; and
      determining the facility by using the second position information, and generating the first position information by using reference information being associated with the facility being determined.
16. The information provision method according to the above described 14 or 15, further including, by the computer, selecting advertisement information by using a time or a date.
17. The information provision method according to any one of the above described 14 to 16, further including,
   by the computer,
   selecting the advertisement information by using an object captured in the image.
18. The information provision method according to the above described 17, wherein
   the image includes a plurality of frame images, and
   at least one of the frame images being used for generating the first position information is not used for selecting the advertisement information, or
   at least one of the frame images being used for selecting the advertisement information is not used for determining the first position information.
19. The information provision method according to any one of the above described 14 to 18, further including,
   by the computer,
   selecting the advertisement information by using a moving direction of the user.
20. The information provision method according to any one of the above described 14 to 19, further including,
   by the computer,
   selecting the advertisement information by using at least one of clothing of a person captured in the image and air temperature.
21. The information provision method according to any one of the above described 14 to 20, further including,
   by the computer,
   selecting the advertisement information by using at least one of attribution information and preference information that relate to the user.
22. The information provision method according to the above described 21, wherein
   the facility is a stop of public transportation, and
   the attribution information includes a purpose of movement using the public transportation by the user.
23. The information provision method according to any one of the above described 14 to 22, further including,
   by the computer,
   selecting the advertisement information by using a number of visits to the facility by the user.
24. The information provision method according to any one of the above described 14 to 23, wherein
   the advertisement information relates to a shop in the facility,
   the information provision method further including,
   by the computer:
   when information indicating that the advertisement information is selected is acquired from the terminal, adding a shop corresponding to the advertisement information as a transit point, and generating the route information being updated; and
   transmitting the route information being updated to the terminal.
25. The information provision method according to the above described 24, further including,
   by the computer:
   when the route information being updated is generated, selecting the advertisement information being new; and
   transmitting the new advertisement information being selected to the terminal together with the route information being updated.
26. An advertisement display method including,
   by a computer executing:
      acquiring the advertisement information and the route information from an information provision apparatus according to any one of the above described 1 to 12; and
      displaying the advertisement information on a screen, and also displaying a mark on the screen by using a current position of a user and the route information, the mark indicating a direction in which the user is to move.
27. A program causing a computer to include:
   an acquisition function of acquiring an image from a terminal held by a user located in a facility;
   a position determination function of generating, by processing the image, first position information indicating a position of the user;
   a route generation function of generating, by using the first position information, route information indicating a route that the user is to move;
   an advertisement selection function of selecting, by using the first position information, advertisement information to be provided to the user; and
   a transmission function of transmitting, to the terminal, the route information and the advertisement information being selected.
28. The program according to the above described 27, wherein
   the image is captured in a facility,
   the acquisition function acquires, from the terminal, second position information indicating a position of the user at a time of entry in the facility, and
   the position determination function determines the facility by using the second position information, and generates the first position information by using reference information being associated with the facility being determined.
29. The program according to the above described 27 or 28, wherein
   the advertisement selection function further selects advertisement information by using a time or a date.
30. The program according to any one of the above described 27 to 29, wherein
   the advertisement selection function further selects the advertisement information by using an object captured in the image.
31. The program according to the above described 30, wherein
   the image includes a plurality of frame images, and
   at least one of the frame images being used by the position determination function is not used by the advertisement selection function, or
   at least one of the frame images being used by the advertisement selection function is not used by the position determination function.
32. The program according to any one of the above described 27 to 31, wherein
   the advertisement selection function further selects the advertisement information by using a moving direction of the user.
33. The program according to any one of the above described 27 to 32, wherein
   the advertisement selection function selects the advertisement information by using at least one of clothing of a person captured in the image and air temperature.
34. The program according to any one of the above described 27 to 33, wherein
   the advertisement selection function selects the advertisement information by using at least one of attribution information and preference information that relate to the user.
35. The program according to the above described 34, wherein
   the facility is a stop of public transportation, and
   the attribution information includes a purpose of movement using the public transportation by the user.
36. The program according to any one of the above described 27 to 35, wherein
   the advertisement selection function selects the advertisement information by using a number of visits to the facility by the user.
37. The program according to any one of the above described 27 to 36, wherein
   the advertisement information relates to a shop in the facility,
   when information indicating that the advertisement information is selected is acquired from the terminal, the route generation function adds a shop corresponding to the advertisement information as a transit point, and generates the route information being updated, and
   the transmission function transmits the route information being updated to the terminal.
38. The program according to the above described 37, wherein,
   when the route information being updated is generated, the advertisement selection function selects the advertisement information being new, and
   the transmission function transmits the new advertisement information being selected to the terminal together with the route information being updated.
39. A program causing a computer to include:
   a communication function of acquiring the advertisement information and the route information from an information provision apparatus according to any one of the above described 1 to 12; and
   a display control function of displaying the advertisement information on a screen, and also displaying a mark on the screen by using a current position of a user and the route information, the mark indicating a direction in which the user is to move.

### REFERENCE SIGNS LIST

10 Information provision apparatus
20 Terminal apparatus
110 Acquisition unit
120 Position determination unit
130 Route generation unit
140 Advertisement selection unit
150 Transmission unit
160 Route-related storage unit
170 Advertisement storage unit
180 User storage unit
210 Image capturing unit
220 Communication unit
230 Display control unit
240 Display
250 Storage unit

What is claimed is:

1. An information provision apparatus comprising:
at least one memory storing instructions; and
at least one processor configured to execute the instructions to:
acquire an image from a terminal held by a user located in a facility;
generate, by processing the image, first position information indicating a position of the user;
generate, by using the first position information, route information indicating a route that the user is to move;
select, by using the first position information, advertisement information to be provided to the user; and
transmit, to the terminal, the route information and the advertisement information being selected.

2. The information provision apparatus according to claim 1, wherein
the image is captured in a facility, and
the at least one processor is further configured to execute the instructions to:
acquire, from the terminal, second position information indicating a position of the user at a time of entry in the facility; facility, and
determine the facility by using the second position information, and generate the first position information by using reference information being associated with the facility being determined.

3. The information provision apparatus according to claim 1, wherein
the at least one processor is further configured to execute the instructions to
further select advertisement information by using a time or a date.

4. The information provision apparatus according to claim 1, wherein
the at least one processor is further configured to execute the instructions to
further select the advertisement information by using an object captured in the image.

5. The information provision apparatus according to claim 4, wherein
the image includes a plurality of frame images, and
at least one of the frame images being used by determining the position is not used by selecting the advertisement information, or
at least one of the frame images being used by selecting the advertisement information is not used by determining the position.

6. The information provision apparatus according to claim 1, wherein
the at least one processor is further configured to execute the instructions to
further select selects the advertisement information by using a moving direction of the user.

7. The information provision apparatus according to claim 1, wherein
the at least one processor is further configured to execute the instructions to
select the advertisement information by using at least one of clothing of a person captured in the image and air temperature.

8. The information provision apparatus according to claim 1, wherein
the at least one processor is further configured to execute the instructions to
select the advertisement information by using at least one of attribution information and preference information that relate to the user.

9. The information provision apparatus according to claim 8, wherein
the facility is a stop of public transportation, and
the attribution information includes a purpose of movement using the public transportation by the user.

10. The information provision apparatus according to claim 1, wherein
the at least one processor is further configured to execute the instructions to
select the advertisement information by using a number of visits to the facility by the user.

11. The information provision apparatus according to claim 1, wherein
the advertisement information relates to a shop in the facility,
the at least one processor is further configured to execute the instructions to:
when information indicating that the advertisement information is selected is acquired from the terminal, add a shop corresponding to the advertisement information as a transit point, and generate the route information being updated; and
transmit the route information being updated to the terminal.

12. The information provision apparatus according to claim 11, wherein,
the at least one processor is further configured to execute the instructions to:
when the route information being updated is generated, select the advertisement information being new; and
transmit the new advertisement information being selected to the terminal together with the route information being updated.

13. A terminal apparatus comprising:
at least one memory configured to store instructions; and
at least one processor configured to execute the instructions to:
acquire the advertisement information and the route information from an information provision apparatus; and
display the advertisement information on a screen, and also display a mark on the screen by using a current position of a user and the route information, the mark indicating a direction in which the user is to move. move, wherein
the information provision apparatus comprises:
at least one memory storing instructions; and
at least one processor configured to execute the instructions to:
acquire an image from a terminal held by a user located in a facility;
generate, by processing the image, first position information indicating a position of the user;
generate, by using the first position information, route information indicating a route that the user is to move;
select, by using the first position information, advertisement information to be provided to the user; and
transmit, to the terminal, the route information and the advertisement information being selected.

14. An information provision method comprising,
by a computer executing:
acquiring an image from a terminal held by a user located in a facility;
generating, by processing the image, first position information indicating a position of the user;
generating, by using the first position information, route information indicating a route that the user is to move;
selecting, by using the first position information, advertisement information to be provided to the user; and
transmitting, to the terminal, the route information and the advertisement information being selected.

15. (canceled)

16. A non-transitory computer-readable storage medium storing a program causing a computer to execute the information provision method according to claim 14.

17. (canceled)
